(19) United States
(12) Patent Application Publication
(10) Pub. No.: US 2018/0029886 A1
(43) Pub. Date: Feb. 1, 2018

(54) METHODS FOR MAKING BORON NITRIDE CERAMIC POWDER

(71) Applicant: ARCONIC INC., Pittsburgh, PA (US)

(72) Inventor: James C. McMillen, Pittsburgh, PA (US)

(21) Appl. No.: 15/660,334

(22) Filed: Jul. 26, 2017

Related U.S. Application Data
(60) Provisional application No. 62/366,863, filed on Jul. 26, 2016.

(51) Int. Cl. C01B 21/064; C04B 35/583

(52) U.S. Cl. CPC C01B 21/0645; C01B 21/0648; C04B 35/583

(57) ABSTRACT

In various embodiments set forth herein, methods of making boron nitride ceramic powder are provided.

### CROSS REFERENCE TO RELATED APPLICATIONS

This application is a non-provisional of and claims priority to U.S. Application Ser. No. 62/366,863, entitled “METHODS FOR MAKING BORON NITRIDE CERAMIC POWDER” filed on Jul. 26, 2016, which is incorporated by reference in its entirety.

### FIELD OF THE INVENTION

Broadly, the present disclosure relates to systems and methods of making ceramic powders. More specifically, the present disclosure relates to carbothermically producing boron nitride powder with support agents (e.g. rigidifying compounds) in combination with to a precursor mixtures, whereby via the support agents, at least one of (1) structural support and (2) gas permeability is provide to the precursor mixture, resulting in higher yields of boron nitride ceramic powder product.

### BACKGROUND

Through carbothermic synthesis, it is possible to make various boride, nitride, and/or carbide ceramic powders. The ceramic powder can then processed into final ceramic products for a wide variety of applications.

### SUMMARY OF THE DISCLOSURE

Broadly, the present disclosure relates to systems and methods of making ceramic powders.

More specifically, the present disclosure relates to utilizing support agents (e.g. rigidifying compounds) in combination with to a precursor mixtures to provide structural support and/or gas permeability to the precursor mixture while it undergoes a chemical transformation via a carbothermic reduction reaction to form a ceramic powder product (e.g. boron nitride).

As compared to the same carbothermic reduction reaction without support agents, with the support agent an improved yield of carbothermically produced boron nitride is realized (e.g. with little, low, or no residual carbon and/or boron carbide produced).

In one aspect, a method is provided, comprising: directing a mixture of components through a hot zone in a reactor, wherein the reactor is configured to accept a nitrogen source, wherein the components include: precursor materials including: a boron source; and a carbon source; and a sufficient amount of a support agent in combination with the precursor materials, wherein the support agent is configured to provide structural support to the precursor materials and enable a permeable precursor materials; heating the components in the hot zone to a temperature sufficient to carbothermically react the precursor materials and the nitrogen source; carbothermically reacting the precursor materials and the nitrogen source to form a boron nitride ceramic material.

In some embodiments, the precursor materials are in solid form in the directing step.

In some embodiments, the reactor is a carbothermic reactor.

In some embodiments, the boron nitride ceramic material is configured with a narrow particle size distribution via the presence of the support agent in the reacting step.

In some embodiments, the boron nitride ceramic material is configured with a generally uniform, plate-like particle shape via the presence of the support agent in the reacting step.

In some embodiments, the nitrogen source is selected from the group consisting of: gaseous nitrogen containing material, nitrogen gas, ammonia, and combinations thereof.

In some embodiments, the carbon source is selected from the group consisting of: carbon black, graphite, coke, carbon resin, and combinations thereof.

In some embodiments, the support agent is selected from the group consisting of: tricalcium orthophosphate, alumina, calcium oxide, magnesium oxide, apatite, hydroxyapatite, and combinations thereof.

In some embodiments, the boron source is selected from the group consisting of: boric oxide, boric acid, and combinations thereof.

In some embodiments, the method includes directing a nitrogen source through the mixture of components during at least one of: the heating step and the carbothermically reacting step.

In some embodiments, the nitrogen source is configured as at least one of: a purge gas and a sweep gas.

In some embodiments, the method includes directing a gaseous mixture comprising the nitrogen source and a carrier gas through the mixture of components during at least one of: the heating step and the carbothermically reacting step.

In some embodiments, the gaseous mixture is configured as at least one of: a purge gas and a sweep gas.

In some embodiments, the carrier gas is selected from the group consisting of: argon and helium.

In some embodiments, the carrier gas is configured at a partial pressure with the nitrogen source to promote the carbothermic reaction of the precursor materials and the nitrogen source to form the boron nitride ceramic material.

In one aspect, a method is provided, comprising: directing a mixture of components through a hot zone in a reactor, wherein the reactor is configured to accept a gaseous nitrogen source, wherein the components include: a plurality of precursor materials including: a boron source; and a carbon source; and greater than 5 wt. % of a non-reactive support agent, wherein the support agent is commingled with the precursor materials such that the mixture of components comprise a gas channel area fraction ranging from at least 0.05 to not greater than 0.5; heating the components in the hot zone to a temperature sufficient to carbothermically react the precursor materials and the nitrogen source; carbothermically reacting the precursor materials and the nitrogen source to form an as-reacted product including: a boron nitride ceramic material and the support agent.

In some embodiments, the method includes processing the as-reacted product via an acid digestion technique to remove the support agent from the boron nitride ceramic material.

In one aspect of the present disclosure, a method is provided, comprising: directing a mixture of components through a hot zone in a reactor, wherein the reactor is configured to accept a gaseous nitrogen source, wherein the components include: a plurality of precursor materials including: a boron source including at least one of boric acid and boric oxide; and a carbon source; and greater than 5 wt. % of a non-reactive support agent, wherein the support agent is commingled with the precursor materials such that the mixture of components comprise a gas channel area fraction ranging from at least 0.05 to not greater than 0.5; heating the components in the hot zone to a temperature sufficient to carbothermically react the precursor materials and the nitrogen source; carbothermically reacting the precursor materials and the nitrogen source to form an as-reacted product including: a boron nitride ceramic material and the support agent; and removing the support agent from the as-reacted product to provide a purified boron nitride ceramic material.

In some embodiments, the removing step further comprises: processing the as-reacted product via an acid digestion technique to remove the support agent from the boron nitride ceramic material.

In some embodiments, the acid digestion technique comprises utilizing an acid selected from the group consisting of: hydrochloric acid, sulfuric acid, nitric acid, and combinations thereof.

In one aspect, a method is provided, comprising: directing a mixture of components through a hot zone in a reactor, wherein the reactor is configured to accept a gaseous nitrogen reagent, wherein the components include: precursor materials including: a boron source; and a carbon source; and a sufficient amount of a support agent in combination with the precursor materials, and configured to provide structural support to the precursor materials and enable a permeable precursor mixture; heating the mixture of solid components in the hot zone to a temperature sufficient to carbothermically react the precursor mixture and gaseous nitrogen reagent, wherein the mixture of solid components is gas permeable; carbothermically reacting the precursor mixture and the gaseous nitrogen reagent to form a boron nitride ceramic material.

In some embodiments, the method additionally and/or alternatively comprise components that are solid components.

In some embodiments, the method additionally and/or in alternatively comprises a reactor that is a carbothermic reactor.

In some embodiments, the method additionally and/or alternatively comprises precursor materials and the support materials that are commingled.

In some embodiments, the method additionally and/or alternatively comprises a resulting boron nitride product that is configured with a narrow particle size distribution.

In some embodiments, the method additionally and/or alternatively comprises a resulting boron nitride product that is configured with a generally uniform, plate-like particle shape.

In some embodiments, the method additionally and/or alternatively includes a support agent comprising tricalcium orthophosphate (i.e. TCP), calcium oxide, alumina, magnesium oxide, apatite, hydroxyapatite, and/or combinations thereof.

In some embodiments, the method additionally and/or alternatively includes a support agent and/or filler materials that are configured to react in a similar manner with B₂O₃ as one or more of the aforementioned materials.

In some embodiments, the method additionally and/or alternatively comprises (post forming), washing/contacting the ceramic material (boron nitride) with an acidic solution (i.e. in the case of TCP, calcium oxide, apatite, hydroxyapatite, and/or combinations thereof).

In some embodiments, the method additionally and/or alternatively comprises (post forming), washing/contacting the ceramic material (boron nitride) with an acidic solution (i.e. in the case of TCP, calcium oxide, apatite, hydroxyapatite, and/or combinations thereof).

In some embodiments, the washing/contacting step additionally and/or alternatively comprises digesting impurities from the ceramic material to remove impurities (e.g. and provide a purified boron nitride product).

In some embodiments, the support agent is additionally and/or alternatively configured to participate in the carbothermic reaction.

In some embodiments, the support agent is additionally and/or alternatively configured to contribute to the carbothermic reduction of the precursor materials into boron nitride powder.

In some embodiments, the support agent is additionally and/or alternatively configured to permit the gaseous nitrogen reagent to enter the components (e.g. solid components).

In some embodiments, the support agent is additionally and/or alternatively configured to permit the gaseous byproducts to exit the components (e.g. solid components).

In some embodiments, the boron source is additionally and/or alternatively boric oxide and/or boric acid. In some embodiments, the boron source is boric acid. In some embodiments, the boron source is boric oxide. In some embodiments, the boron source is boric acid and boric oxide (e.g. mixture, commingled).

In some embodiments, the carbon source is selected from the group of: carbon black, graphite, coke, carbon resins, and/or combinations thereof.

In some embodiments, the support agent is additionally and/or alternatively present in an amount of greater than 5 wt. %.

In some embodiments, the nitrogen source is additionally and/or alternatively, selected from the group consisting of: nitrogen gas, ammonia, and combinations thereof.

In some embodiments, the nitrogen source is admixed with another gas (e.g. non-reactive gas and/or gas that is not a precursor to the carbothermic reaction to form ceramic product). Some non-limiting examples of a gas admixed/commingled with the nitrogen source include: argon, helium, and combinations thereof). In this embodiment, the gases are admixed with the appropriate partial pressure of nitrogen source such that the nitrogen source is stoichiometrically sufficient for the carbothermic reaction, or at a stoichiometric excess, but so excessive as to waste nitrogen source/nitrogen containing gas (e.g. far surpassing the stoichiometric needs).

In some embodiments, the nitrogen source is varied throughout the duration of the reaction (e.g. initiated at 100% nitrogen source, then admixed to variable partial pressures with a carrier gas/non-precursor gas source to promote the reaction while not greatly exceeding the stoichiometric requirements of nitrogen source, and optionally tapered to 100% carrier gas towards the full conversion of reagents/precursors to reaction product/ceramic product).

In some embodiments, the gas additionally and/or alternatively configured as a sweep gas.

In some embodiments, the gas is additionally and/or alternatively configured as a purge gas.

Various ones of the inventive aspects noted hereinabove may be combined to yield methods and systems of making ceramic powder (boron nitride ceramic powder).

These and other aspects, advantages, and novel features of the invention are set forth in part in the description that follows and will become apparent to those skilled in the art upon examination of the following description and figures, or may be learned by practicing the invention.

### BRIEF DESCRIPTION OF THE DRAWINGS

FIG. 1 is a graph depicting thermodynamic models of three different carbothermic reactions to produce boron nitride, showing the relationship of the Gibbs Free Energy (J) vs. Temperature (K) for each reaction, in accordance with one or more embodiments of the present disclosure.

FIGS. 2A and 2B illustrate the contrasting results of two boron nitride powders synthesized under the same stoichiometric conditions and reaction conditions, where FIG. 2A depicts boron nitride powder reacted without a support agent and FIG. 2B depicts boron nitride powder reacted with a support agent commingled with the precursor mixture (i.e. 7 wt % TCP filler), in accordance with one or more embodiments of the present disclosure.

FIG. 3 depicts a graph of experimental results, more specifically, the reacted product carbon level (wt. %) vs. precursor carbon level (carbon coefficient, stoichiometric level) for comparative runs of carbothermic synthesis of boron nitride, comparing runs without support agents (no TCP) to runs with TCP (i.e. runs each had an addition of 7 wt. % TCP), in accordance with various embodiments of the present disclosure.

FIG. 4 depicts an alternative representation of the experimental information, depicting that a lower synthesis temperature can be used in a carbothermic reduction having precursor material with support agents, as compared to a carbothermic reduction without support agents/filled precursor materials, in accordance with one or more embodiments of the present disclosure.

FIGS. 5A-5C depict data corresponding to experiments in accordance with one or more embodiments of the present disclosure: that boron nitride produced with support agents/fillers generally have a coarser particle size than boron nitride produced with unfilled precursors (no support agent present).

FIG. 5A depicts a high magnification SEM image of the resulting product from a carbothermic reaction having 1.5C with 7 wt. % TCP support agent/filler, in accordance with one or more embodiments of the present disclosure.

FIG. 5B depicts a high magnification SEM image of the resulting product from a carbothermic reaction having 1.5C with no filler/support agent, as a comparison to the various embodiments disclosed herein.

FIG. 5C depicts a high magnification SEM image of a commercially available boron nitride powder, as a comparison to the various embodiments disclosed herein.

FIGS. 6A-6B depict experimental data of two high magnification SEM images comparing filled (support agent) and unfilled (no support agent) processes (carbothermic reactions), 6A includes 1.5C, with 7 wt % TCP support agent/filler while FIG. 6B includes 1.5C with no support agent/filler.

FIG. 7A-7C depict experimental data: photographs of as-reacted boron nitride ceramic powder product (commingled with support agent) and a graph of experimental data depicting product carbon content (wt. %) vs. additive filler level (wt. %) for 5 wt. %, 7 wt. % and 9 wt. % hydroxyapatite/TCP.

FIG. 7A depicts the as-reacted ceramic powder product commingled with support agent: 5 wt. % TCP, with some visually observable deformation of the as-reacted volume of ceramic powder (as compared to the volume of precursor granules).

FIG. 7B depicts the as-reacted ceramic powder product commingled with support agent: 9 wt. % TCP, with depicts the as-reacted boron nitride powder with very little visually observable deformation of the as-reacted volume of the ceramic powder (as compared to the volume of precursor granules).

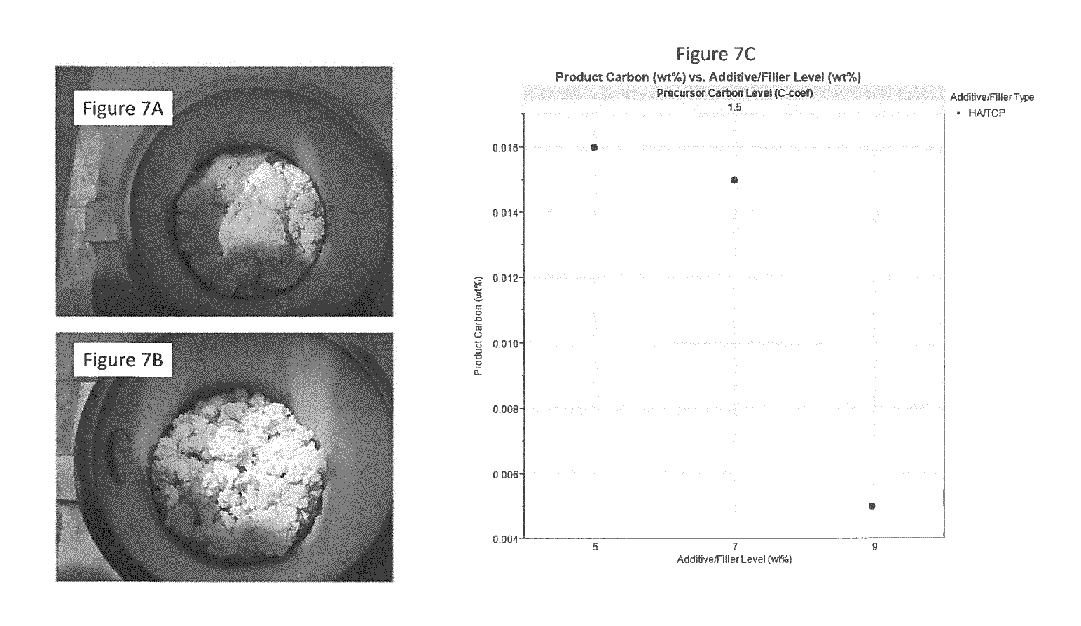

As depicted in FIG. 7C, carbon levels were low for all filler levels tested, although a downward trend of product carbon with filler level exists. As shown in FIG. 7C, out of the three data points plotted, the lowest carbon level with the least amount of visually observable deformation using the lowest amount of filler, provided a 7 wt. % addition of TCP as the support agent. As depicted in the graph of FIG. 7C, without being bound by any mechanism or theory, a filler level of greater than 5 wt. % TCP as a support agent is believed to optimize the granular porosity and reduce the level of deformation during synthesis of the boron nitride ceramic powder product.

### DETAILED DESCRIPTION

Reference will now be made in detail to the accompanying drawings, which at least assist in illustrating various pertinent embodiments of the present invention

The present invention will be further explained with reference to the attached drawings, wherein like structures are referred to by like numerals throughout the several views. The drawings shown are not necessarily to scale, with emphasis instead generally being placed upon illustrating the principles of the present invention. Further, some features may be exaggerated to show details of particular components.

The figures constitute a part of this specification and include illustrative embodiments of the present invention and illustrate various objects and features thereof. Further, the figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

Among those benefits and improvements that have been disclosed, other objects and advantages of this invention will become apparent from the following description taken in conjunction with the accompanying figures. Detailed embodiments of the present invention are disclosed herein; however, it is to be understood that the disclosed embodiments are merely illustrative of the invention that may be embodied in various forms. In addition, each of the examples given in connection with the various embodiments of the invention which are intended to be illustrative, and not restrictive.

Throughout the specification and defined embodiments, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.

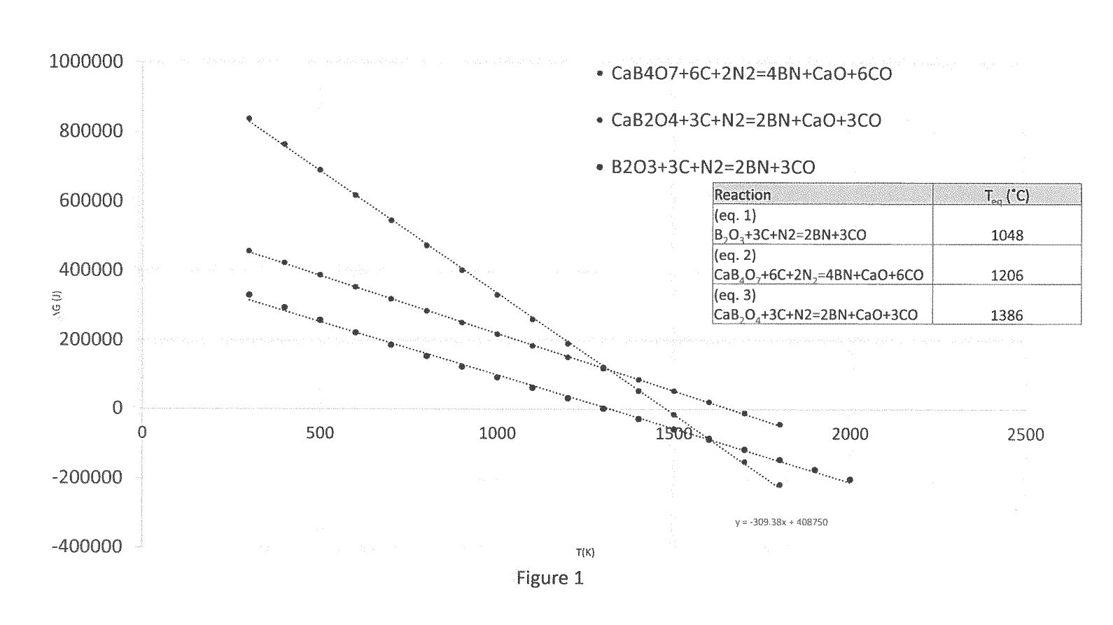

FIG. 1 is a graph depicting thermodynamic models of three different reactions which produce boron nitride, labeled as equation 1-3. The plot of FIG. 1 depicts the Gibbs Free Energy (J) vs. Temperature (K) for each reaction.

The carbothermic reduction to form boron nitride (B₂O₃+3C+N₂=2BN+3CO) has a Gibbs Free Energy which indicates an initiation of 1048° C. The other two reactions: CaB₄O₇+6C+2N₂=4BN+CaO+6CO and CaB₂O₄+3C+N₂=2BN+CaO+3CO depict two examples of support agent intermediate reactions (i.e. compounds formed from the support agent and boron oxide) during carbothermic reduction conditions (i.e. participating in the chemical synthesis of boron nitride powder) to provide boron nitride product.

The second reaction, CaB₄O₇+6C+2N₂=4BN+CaO+6CO, initiates the reaction at 1206° C., while the third other reaction, CaB₂O₄+3C+N₂=2BN+CaO+3CO, has an initiation temperature of 1386° C. The second and third reactions depicted are decomposition of boron containing intermediates that are formed from the original support agent during the reaction process including calcium phosphate based fillers (Ca₃(PO₄)₂(TCP) and/or Ca₅(PO₄)₃OH (hydroxyapatite, or HA)).

Without being bound by any mechanism or theory, these support agents are believed to decompose and react with B₂O₃ to form calcium borates during synthesis. Then, as with the first listed reaction, the borates formed also react with carbon and nitrogen to form boron nitride. As shown in the reactions, the remaining support agent is believed to be converted to calcium oxide (e.g. removed via acid digestion). As CaO is formed, the calcium oxide is stable in reducing atmospheres at BN synthesis temperatures (1400° C.-1600° C.), thus providing a support structure to the adjacent precursor materials.

Also, as shown by FIG. 1, CaO forms borides at a much higher temperature than the boron nitride synthesis. In this embodiment, the reacted support agent (i.e. CaO) formed from the support agents participating in the carbothermic reduction, such that a reacted support agent remains (is present) in the precursor mixture as it undergoes chemical transformation from precursor mixture (and support agent) to ceramic material (BN powder) and reacted support agent.

As such, the support agent is specifically designed and/or configured to provide structural support to the precursor mixture and/or resulting ceramic material throughout the chemical transformation, while participating in the synthesis to form ceramic material (e.g. BN powder). Thus, the support agent is configured with a support function, where the precursor mixture does not significantly deform upon heating, such that gas is permitted to flow through the inter-granular pores and intra-granular pores of the reacting material.

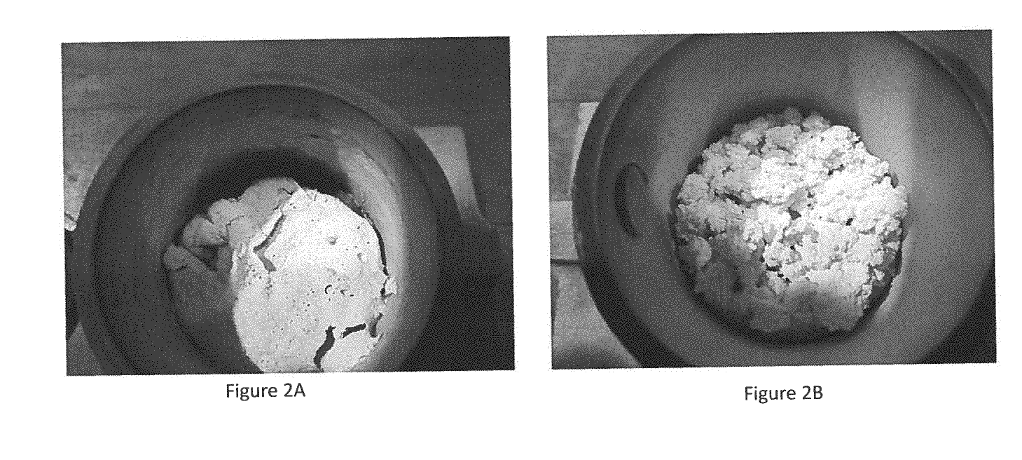

FIGS. 2A and 2B illustrate two boron nitride powders synthesized under the same stoichiometric conditions and reaction conditions, where 2A depicts boron nitride powder reacted without a support agent and 2B depicts boron nitride powder reacted with a support agent commingled with the precursor mixture (i.e. 7 wt % TCP filler).

In stark contrast, the resulting ceramic powder without a support agent is a deformed monolithic form which includes a lot of unreacted precursor mixture and a large content of boron carbide with the boron nitride as compared to the ceramic powder carbothermically produced with the support agent. FIG. 2B depicts a boron nitride powder which includes visible intergranular pores/porosity in the as-reacted ceramic material, indicative of the support agent maintaining gas and thermal permeability conditions throughout the carbothermic reaction. The boron nitride powder of FIG. 2B depicts fully reacted precursor and a low to zero content of unreacted carbon and/or boron carbide byproduct.

More specifically, FIG. 2A depicts significantly deformed ceramic material (e.g. deformation upon heating to the reaction temperature of the precursor mixture), whereas FIG. 2B has maintained inter- and intra-granular pores in the precursor such that the permeable form is readily observable in the as-reacted powder. As both runs had the same weight of precursor, the volume change was due to melting (i.e. fusion of the precursor mixture).

Additionally, with a complete or near complete reaction of the carbon, it is believed that higher precursor carbon levels can be used with support agents as compared to carbothermic reduction without support agents, thus leading to higher/improved BN productivity. Additionally, with FIG. 1 and FIG. 2B, it is observed that lower reactor temperatures are required to completely react the material in the reactor with support agents, as compared with a carbothermic reduction without support agents.

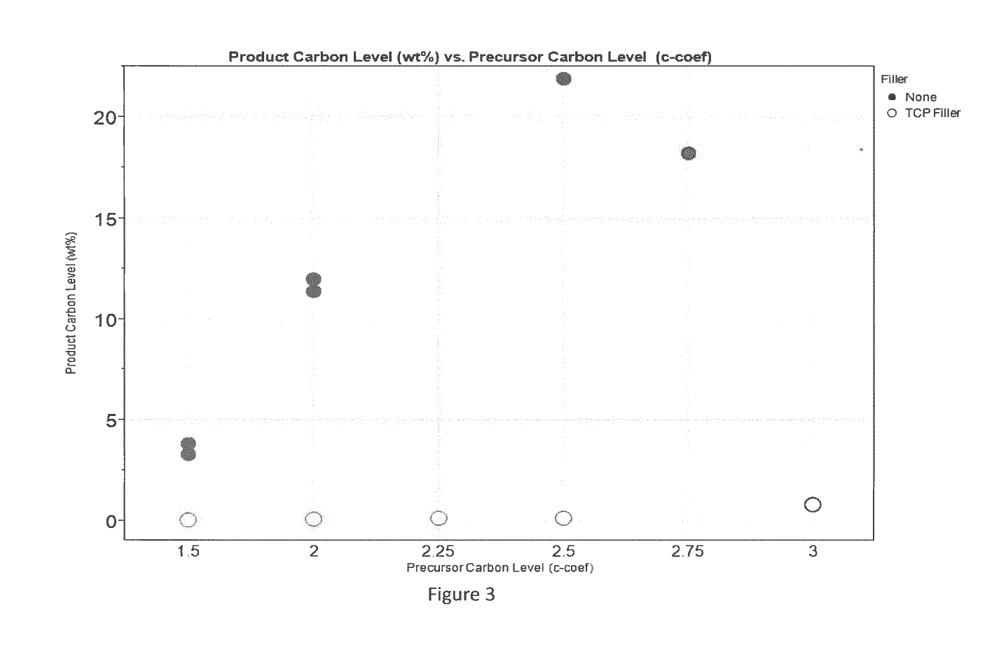

FIG. 3 depicts a graph of the reacted product carbon level (wt. %) vs. precursor carbon level (carbon coefficient, stoichiometric level) for comparative runs of carbothermic synthesis of boron nitride, comparing runs without support agents (no TCP) to runs with TCP (i.e. runs each had an addition of 7 wt. % TCP). As depicted by FIG. 3, low product carbon level is a key indicator of high reaction efficiency and carbon is the limiting reagent in these boron nitride precursors.

As illustrated in FIG. 3, with support agents/filler present, the carbon level of the precursor is reduced to near zero levels for all variations in the amount of carbon precursor in the reagents. Comparatively, the product carbon levels for runs without TCP filler are much higher, which is believed to indicate a composite product (i.e. boron nitride commingled with unreacted carbon and/or boron carbide. Thus, FIG. 3 indicates that the support agent/filler material allows carbon level in the precursor to be increased while maintaining low product carbon levels.

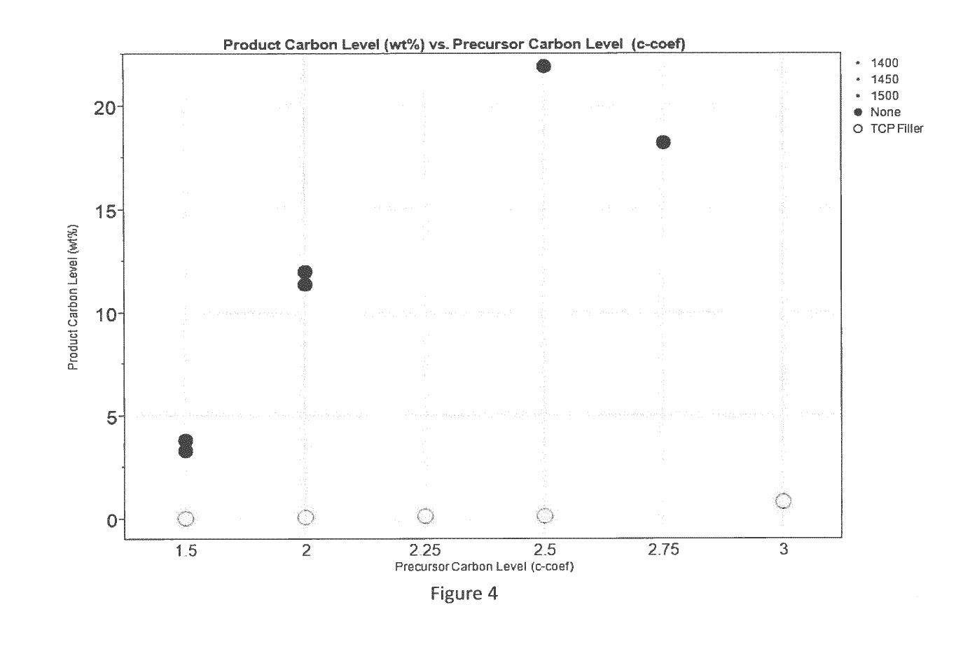

FIG. 4 depicts an alternative representation of the data showing that a lower synthesis temperature can be used in a carbothermic reduction having precursor material with support agents as compared to a carbothermic reduction without support agents/filled precursor materials.

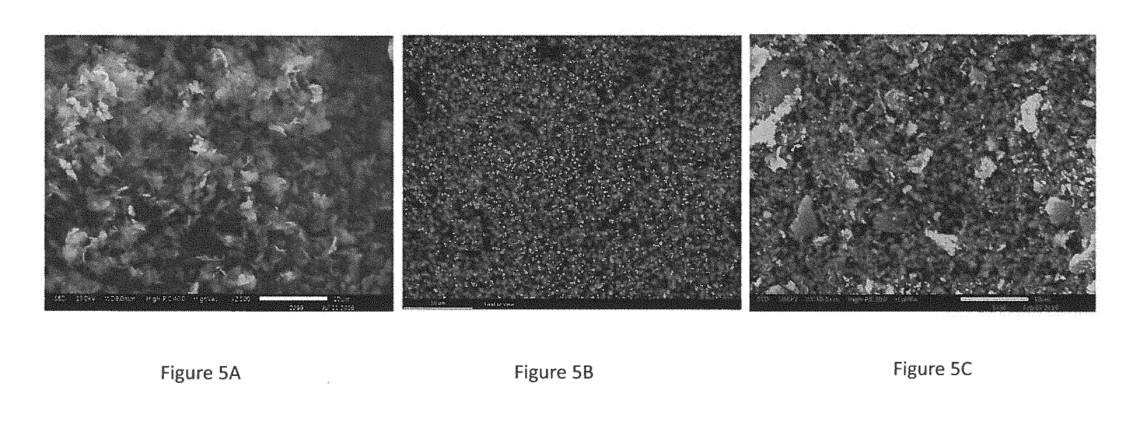

FIG. 5A-5C depict that boron nitride produced with support agents/fillers have a coarser particle size than boron nitride produced with unfilled precursors (no support agent present). FIG. 5A depicts a carbothermic reaction having 1.5C with 7 wt. % TCP support agent/filler. FIG. 5B depicts a carbothermic reaction having 1.5C with no filler. FIG. 5C depicts a commercially available boron nitride powder.

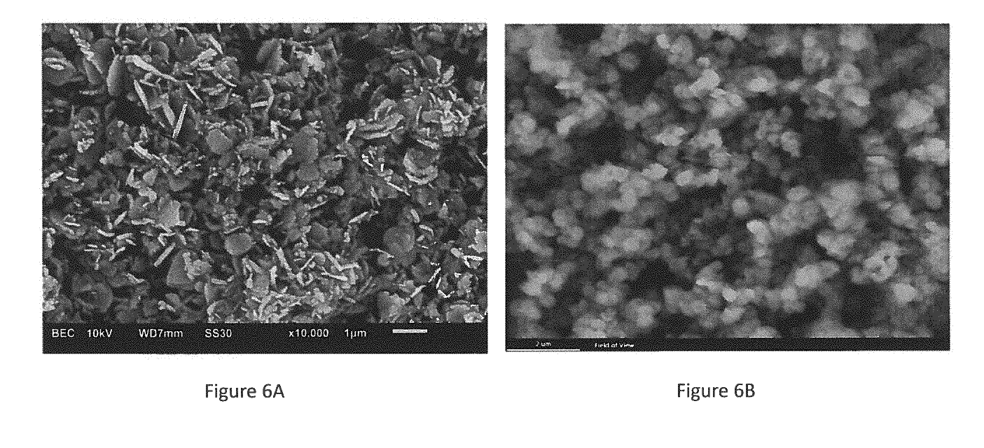

FIGS. 6A-6B depict high magnification images comparing filled and unfilled processes, 6A includes 1.5C, with 7 wt % TCP support agent/filler while FIG. 6B includes 1.5C with no support agent/filler.

FIG. 7A-7C depicts photographs of reacted boron nitride ceramic powder product and a graph depicting product carbon (wt. %) vs. additive filler level (wt. %) for 5 wt. %, 7 wt. % and 9 wt. % hydroxyapatite/TCP. FIG. 7A depicts 5 wt. % TCP, with some visually observable deformation of the as-reacted volume of ceramic powder (as compared to the volume of precursor granules).

FIG. 7B depicts 9 wt. % TCP, with depicts the as-reacted boron nitride powder with very little visually observable deformation of the as-reacted volume of the ceramic powder (as compared to the volume of precursor granules).

As depicted in FIG. 7C, a filler level of greater than 5 wt. % TCP as a support agent is believed to optimize the granular porosity and reduce the level of deformation during synthesis. As depicted in FIG. 7C, carbon levels were low for all filler levels tested, although a downward trend of product carbon with filler level exists. As shown in FIG. 7C, out of the three data points plotted, the lowest carbon level with the least amount of visually observable deformation using the lowest amount of filler, provided a 7 wt. % addition of TCP as the support agent.

As a non-limiting example, a method of making boron nitride includes (additionally and/or alternatively, the following steps): mixing the precursor materials, dehydrating the precursor materials, reacting (carbothermically reacting) the precursor mixture to form boron nitride powder, crushing the reactor material (ceramic product, including boron nitride powder and reacted support agent) into powder (i.e. cake breaking), digesting the ceramic material in a solvent to remove reacted support agent (i.e. hydrochloric acid for Ca-based support agents/fillers, basic solvent (e.g. NaOH) for alumina or magnesium oxide based support agents/fillers), filtering the solvent containing dissolved support agent to separate the ceramic powder product (boron nitride) from the dissolved support agent/filler solution, drying the filtrate (containing the boron nitride powder), and deagglomerating the powder to configure the powder into particulate form.

In some embodiments, the support agent is present in a weight percent (based on the total weight of solid components as): at least 1 wt. %; at least 2 wt. %; at least 3 wt. %; at least 4 wt. %; at least 5 wt. %: at least 6 wt. %; at least 7 wt. %; at least 8 wt. %; at least 9 wt. %; at least 10 wt. %; at least 11 wt. %; at least 12 wt. %; at least 13 wt. % at least 14 wt. %: at least 15 wt. %; at least 16 wt. %; at least 17 wt. %; at least 18 wt. %; at least 19 wt. %; or at least 20 wt. %.

In some embodiments, the support agent is present in a weight percent (based on the total weight of solid components as): not greater than 1 wt. %; not greater than 2 wt. %; not greater than 3 wt. %; not greater than 4 wt. %; not greater than 5 wt. %: not greater than 6 wt. %; not greater than 7 wt. %; not greater than 8 wt. %; not greater than 9 wt. %; not greater than 10 wt. %; not greater than 11 wt. %; not greater than 12 wt. %; not greater than 13 wt. % not greater than 14 wt. %: not greater than 15 wt. %; not greater than 16 wt. %; not greater than 17 wt. %; not greater than 18 wt. %; not greater than 19 wt. %; or not greater than 20 wt. %.

In some embodiments, the support agent (TCP) is present in the solid components at greater than 5 wt. %.

In some embodiments, the support agent (TCP) is present in the solid components at 7 wt. %.

In some embodiments, the support agent (TCP) is present in the solid components at 9 wt. %.

In some embodiments, the support agent (TCP) is present in the solid components at 10 wt. %.

In some embodiments, the support agent (TCP) is present in the solid components at 13 wt. %.

In some embodiments, the support agent (TCP) is present in the solid components at 15 wt. %.

In some embodiments, the solid components are configured with (a) at least one gas channel and (b) macro-porosity in at least a portion of the solid components (e.g. where macro-porosity refers to sufficiently sized voids to permit gas to permeate through the solid components).

In some embodiments, the solid components are configured to take up at least 0.5 area fraction; at least 0.55 area fraction; at least 0.6 area fraction; at least 0.65 area fraction; at least 0.7 area fraction; at least 0.75 area fraction; at least 0.8 area fraction; at least 0.85 area fraction; at least 0.9 area fraction; or at least 0.95 area fraction, when viewing a cross-sectional area across the reaction chamber.

In some embodiments, the solid components is configured to take up not greater than 0.5 area fraction; not greater than 0.55 area fraction; not greater than 0.6 area fraction; not greater than 0.65 area fraction; not greater than 0.7 area fraction; not greater than 0.75 area fraction; not greater than 0.8 area fraction; not greater than 0.85 area fraction; not greater than 0.9 area fraction; or not greater than 0.95 area fraction, when viewing a cross-sectional area across the reaction chamber.

In some embodiments, the solid components are configured to take up 0.5 area fraction to not greater than 0.95 area fraction of a cross-sectional area taken across the reaction chamber. In some embodiments, the solid components are configured to take up 0.6 area fraction to not greater than 0.9 area fraction of a cross-sectional area taken across the reaction chamber. In some embodiments, the solid components are configured to take up 0.75 area fraction to not greater than 0.85 area fraction of a cross-sectional area taken across the reaction chamber.

In some embodiments, the solid components are configured from a plurality of granules. In some embodiments, the solid components are configured with inter-granule porosity, which is measured between granules of a single solid components.

In some embodiments, the inter-granule porosity is configured to take up at least 0.1 area fraction; at least 0.2 area fraction; at least 0.3 area fraction; at least 0.4 area fraction; at least 0.5 area fraction; at least 0.6 area fraction; at least 0.7 area fraction; or at least 0.8 area fraction, when viewing a cross-sectional area across the reaction chamber.

In some embodiments, the inter-granule porosity is configured to take up not greater than 0.1 area fraction; not greater than 0.2 area fraction; not greater than 0.3 area fraction; not greater than 0.4 area fraction; not greater than 0.5 area fraction; not greater than 0.6 area fraction; not greater than 0.7 area fraction; or not greater than 0.8 area fraction, when viewing a cross-sectional area across the reaction chamber.

In some embodiments, the inter-granule porosity is configured to take up 0.1 area fraction to not greater than 0.8 area fraction of a cross-sectional area taken across the reaction chamber. In some embodiments, the solid components are configured to take up 0.2 area fraction to not greater than 0.7 area fraction of a cross-sectional area taken across the reaction chamber. In some embodiments, the solid components are configured to take up 0.3 area fraction to not greater than 0.6 area fraction of a cross-sectional area taken across the reaction chamber.

In some embodiments, the solid components are configured with intra-granule porosity, which is measured within a single granule (e.g. porosity between precursor mixture/reagents).

In some embodiments, there is inter-granule porosity and no intra-granular porosity (0 area fraction).

In some embodiments, the intra-granule porosity is configured to take up at least 0.01 area fraction; at least 0.05 area fraction; at least 0.1 area fraction; at least 0.2 area fraction; at least 0.3 area fraction; at least 0.4 area fraction; at least 0.5 area fraction; or at least 0.6 area fraction, when viewing a cross-sectional area across the reaction chamber.

In some embodiments, the intra-granule porosity is configured to take up not greater than 0.01 area fraction; not greater than 0.05 area fraction; not greater than 0.1 area fraction; not greater than 0.2 area fraction; not greater than 0.3 area fraction; not greater than 0.4 area fraction; not greater than 0.5 area fraction; or not greater than 0.6 area fraction, when viewing a cross-sectional area across the reaction chamber.

In some embodiments, the inter-granule porosity is configured to take up 0.01 area fraction to not greater than 0.6 area fraction of a cross-sectional area taken across the reaction chamber. In some embodiments, the solid components are configured to take up 0.1 area fraction to not greater than 0.5 area fraction of a cross-sectional area taken across the reaction chamber. In some embodiments, the solid components are configured to take up 0.2 area fraction to not greater than 0.5 area fraction of a cross-sectional area taken across the reaction chamber. In some embodiments, the solid components are configured to take up 0.3 area fraction to not greater than 0.4 area fraction of a cross-sectional area taken across the reaction chamber.

In some embodiments, the solid components are configured with at least one gas channel.

As used herein, “gas channel” refers to the open space/volume that is not taken up by the solid components (and/or the container, if a container is utilized), in the cross-sectional area of the reaction chamber. In some embodiments, the gas channel is configured in a direction parallel to the gas flow through the solid components.

In some embodiments, the gas channel is configured to take up at least 0.05 area fraction; at least 0.1 area fraction; at least 0.15 area fraction; at least 0.2 area fraction; at least 0.25 area fraction; at least 0.3 area fraction; at least 0.35 area fraction; at least 0.4 area fraction; 0.45 area fraction; at least 0.5 area fraction; when viewing a cross-sectional area across the reaction chamber.

In some embodiments, the gas channel is configured to take up not greater than 0.05 area fraction; not greater than 0.1 area fraction; not greater than 0.15 area fraction; not greater than 0.2 area fraction; not greater than 0.25 area fraction; not greater than 0.3 area fraction; not greater than 0.35 area fraction; not greater than 0.4 area fraction; 0.45 area fraction; not greater than 0.5 area fraction; when viewing a cross-sectional area across the reaction chamber.

In some embodiments, the gas channel is configured to take up 0.5 area fraction to not greater than 0.05 area fraction, of a cross-sectional area taken across the solid components configured in the reactor. In some embodiments, the gas channel is configured to take up 0.3 area fraction to not greater than 0.1 area fraction, of a cross-sectional area taken across the solid components configured in the reaction chamber. In some embodiments, the gas channel is configured to take up 0.4 area fraction to not greater than 0.2 area fraction, of a cross-sectional area taken across the solid components configured in the reaction chamber. In some embodiments, the gas channel is configured to take up 0.4 area fraction to not greater than 0.1 area fraction, of a cross-sectional area taken across the solid components configured in the reaction chamber.

Example of Post Forming Processing (e.g. Ceramic Material Purification):

After the reaction is complete, post-forming processing can be completed to purify the ceramic powder product (e.g. boron nitride ceramic material) and/or remove the support material/filler from the boron nitride.

The as-reacted material (containing ceramic powder product and support agent/filler) is removed from the reactor and processed via a cake breaking process (e.g. crushed to break up the as-reacted cake material). Next, the crushed material is processed via an acid digestion to remove the support agent from the ceramic powder product.

In some embodiments, the crushed, as-reacted material is dispersed in an acid solution to dissolve the support agent and promote physical separation of the ceramic powder product (solid) from the support agent (by directing the support agent from a solid phase into a liquid phase/solution phase). Next, the solute is filtered from the filtrate via a filtration/separation process (e.g. suction filtration, pressure/gas filtration techniques). The purified boron nitride ceramic powder product can then be dried to remove excess moisture.

While various embodiments of the present invention have been described in detail, it is apparent that modifications and adaptations of those embodiments will occur to those skilled in the art. However, it is to be expressly understood that such modifications and adaptations are within the spirit and scope of the present invention.

What is claimed is:

1. A method, comprising:
directing a mixture of components through a hot zone in a reactor, wherein the reactor is configured to accept a nitrogen source, wherein the components include:
(1) precursor materials including:
a boron source; and
a carbon source; and
(2) a sufficient amount of a support agent in combination with the precursor materials, wherein the support agent is configured to provide structural support to the precursor materials and enable a permeable precursor materials;
heating the components in the hot zone to a temperature sufficient to carbothermically react the precursor materials and the nitrogen source;
carbothermically reacting the precursor materials and the nitrogen source to form a boron nitride ceramic material.

2. The method of claim 1, wherein the precursor materials are in solid form in the directing step.

3. The method of claim 1, wherein the reactor is a carbothermic reactor.

4. The method of claim 1, wherein the boron nitride ceramic material is configured with a narrow particle size distribution via the presence of the support agent in the reacting step.

5. The method of claim 1, wherein the boron nitride ceramic material is configured with a generally uniform, plate-like particle shape via the presence of the support agent in the reacting step.

6. The method of claim 1, wherein the nitrogen source is selected from the group consisting of: gaseous nitrogen containing material, nitrogen gas, ammonia, and combinations thereof.

7. The method of claim 1, wherein the carbon source is selected from the group consisting of: carbon black, graphite, coke, carbon resin, and combinations thereof.

8. The method of claim 1, wherein the support agent is selected from the group consisting of: tricalcium orthophosphate, alumina, calcium oxide, magnesium oxide, apatite, hydroxyapatite, and combinations thereof.

9. The method of claim 1, wherein the boron source is selected from the group consisting of: boric oxide, boric acid, and combinations thereof.

10. The method of claim 1, further comprising:
directing a nitrogen source through the mixture of components during at least one of: the heating step and the carbothermically reacting step.

11. The method of claim 10, wherein the nitrogen source is configured as at least one of: a purge gas and a sweep gas.

12. The method of claim 1, further comprising:
directing a gaseous mixture comprising the nitrogen source and a carrier gas through the mixture of components during at least one of: the heating step and the carbothermically reacting step.

13. The method of claim 12, wherein the gaseous mixture is configured as at least one of: a purge gas and a sweep gas.

14. The method of claim 12, wherein the carrier gas is selected from the group consisting of: argon and helium.

15. The method of claim 12, wherein the carrier gas is configured at a partial pressure with the nitrogen source to promote the carbothermic reaction of the precursor materials and the nitrogen source to form the boron nitride ceramic material.

16. A method, comprising:
directing a mixture of components through a hot zone in a reactor, wherein the reactor is configured to accept a gaseous nitrogen source, wherein the components include:
(a) a plurality of precursor materials including:
a boron source; and
a carbon source; and
(b) greater than 5 wt. % of a non-reactive support agent, wherein the support agent is commingled with the precursor materials such that the mixture of components comprise a gas channel area fraction ranging from at least 0.05 to not greater than 0.5;
heating the components in the hot zone to a temperature sufficient to carbothermically react the precursor materials and the nitrogen source;
carbothermically reacting the precursor materials and the nitrogen source to form an as-reacted product including: a boron nitride ceramic material and the support agent.

17. The method of claim 16, further comprising:
processing the as-reacted product via an acid digestion technique to remove the support agent from the boron nitride ceramic material.

18. A method, comprising:
directing a mixture of components through a hot zone in a reactor, wherein the reactor is configured to accept a gaseous nitrogen source, wherein the components include:
(a) a plurality of precursor materials including:
a boron source including at least one of boric acid and boric oxide; and
a carbon source; and
(b) greater than 5 wt. % of a non-reactive support agent, wherein the support agent is commingled with the precursor materials such that the mixture of components comprise a gas channel area fraction ranging from at least 0.05 to not greater than 0.5;
heating the components in the hot zone to a temperature sufficient to carbothermically react the precursor materials and the nitrogen source;
carbothermically reacting the precursor materials and the nitrogen source to form an as-reacted product including: a boron nitride ceramic material and the support agent; and
removing the support agent from the as-reacted product to provide a purified boron nitride ceramic material.

19. The method of claim 18, wherein the removing step further comprises: processing the as-reacted product via an acid digestion technique to remove the support agent from the boron nitride ceramic material.

20. The method of claim 19, wherein the acid digestion technique comprises an acid selected from the group consisting of: hydrochloric acid, sulfuric acid, nitric acid, and combinations thereof.
